(19) United States
(12) Patent Application Publication
(10) Pub. No.: US 2004/0156402 A1
(43) Pub. Date: Aug. 12, 2004

(54) Fiber laser apparatus, image display apparatus and method of exciting up-conversion fiber laser apparatus

(75) Inventors: Masaki Tsuchida, Fukaya-shi (JP); Kiyoyuki Kawai, Higashikurume-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/743,257

(22) Filed: Dec. 23, 2003

(30) Foreign Application Priority Data
Dec. 27, 2002 (JP) 2002-380281

(51) Int. Cl. H01S 3/30

(52) U.S. Cl. 372/6

(57) ABSTRACT

A fiber laser apparatus, an image display apparatus and an excitation method for an up-conversion fiber laser apparatus are disclosed. A polarizer and a high-reflection mirror for retrieving an up-conversion laser output are interposed between an exciting laser for emitting an exciting laser beam and a rare-earth-doped fiber. That portion of the exciting laser beam output from the output side of the rare-earth-doped fiber which has a polarized wave directed at right angles to the polarized wave incident on the rare-earth-doped fiber is returned into the rare-earth-doped fiber. The exciting laser beam having the other polarized wave is output in a direction different from the direction of the exciting laser.

### CROSS-REFERENCE TO RELATED APPLICATIONS

This application is based upon and claims the benefit of priority from the prior Japanese Patent Application No. 2002-380281, filed Dec. 27, 2002, the entire contents of which are incorporated herein by reference.

### BACKGROUND OF THE INVENTION

1. Field of the Invention

The present invention relates to an up-conversion fiber laser apparatus for producing a desired laser beam by exciting an optical fiber with a rare earth doped thereto by means of an exciting laser beam, an image display apparatus having fiber laser apparatuses as light sources and a method of exciting the up-conversion fiber laser apparatus.

2. Description of the Related Art

In an up-conversion fiber laser apparatus having a semiconductor laser as an exciting laser, for example, it is known that an exciting laser beam is absorbed in the up-conversion fiber with a rare earth doped thereto while part of the exciting laser beam is output from the fiber without being absorbed.

With the intention of improving the utilization rate of the exciting laser beam, a mirror for reflecting the exciting laser beam at high efficiency is mounted on the output side of the fiber, so that the exciting laser beam that has reached the output side without being used is reflected and reused.

Jpn. Pat. Appln. KOKAI Publication No. 2000-339735, for example, proposes a method of improving the utilization rate of the exciting laser beam in which reflection means is arranged at each end of an up-conversion fiber thereby to constitute an optical resonance structure whereby the reflectivity of the reflection means is improved especially on the light source side.

On the other hand, Jpn. Pat. Appln. KOKAI Publication No. 2002-94156 proposes an image display apparatus in which the wavelength of an up-conversion fiber is switched by time division thereby to make up a light source.

The utilization rate of the exciting laser beam is improved by returning the exciting laser beam into the up-conversion fiber. However, all the light beam reflected on the output side and returned, i.e., all the exciting laser beam reflected is not absorbed, but part of the returned light beam is returned to the semiconductor laser without being used.

Also, in the case where the up-conversion fiber laser apparatus is used as a display light source, the utilization rate of the exciting laser beam can be improved by imparting a property for reflecting the exciting laser beam at high efficiency to the up-conversion fiber, i.e., on the output side of the up-conversion fiber with the rare earth doped thereto. Nevertheless, the light beam returned to the semiconductor laser constituting the light source of the exciting laser beam from the rare-earth-doped fiber has such an effect as to fluctuate the oscillation efficiency of the semiconductor laser. Therefore, a light isolator may be used between the semiconductor laser and the fiber.

The problem remains, however, that the light isolator is very expensive and not suitable for applications of a high-density operation.

### BRIEF SUMMARY OF THE INVENTION

According to an aspect of the present invention, there is provided an up-conversion fiber laser apparatus for exciting a rare-earth-doped fiber by a laser beam, comprising: a polarizer and a high-reflection mirror for retrieving an up-conversion laser output, which are arranged between an exciting laser for emitting an exciting laser beam and the rare-earth-doped fiber, wherein that portion of the exciting laser output from the output side of the rare-earth-doped fiber which has polarized waves at right angles to the polarized waves of the light beam incident or the rare-earth-doped fiber is returned into the rare-earth-doped fiber again, and the exciting laser beam having the other polarized waves are output in a direction different from the exciting laser.

According to another aspect of the present invention, there is provided a fiber laser apparatus comprising: an exciting laser for emitting an exciting laser beam; an up-conversion fiber excited by the exciting laser beam and adapted to output a laser beam of a wavelength predetermined in accordance with the rare-earth doped in advance; a polarizer interposed between the exciting laser and the up-conversion fiber for transmitting the light beam having a polarized wave component unique to the exciting laser beam and reflecting the light beam having a polarized wave component at right angles to the unique polarized wave component; and an output mirror arranged on the output side of the up-conversion fiber and adapted to guide, in a predetermined direction different from the exciting laser, the output laser beam output from the up-conversion fiber and the portion of the exciting laser beam not contributing to the excitation of the up-conversion fiber of the exciting laser beam.

According to still another aspect of the present invention, there is provided an exciting method for an up-conversion fiber laser apparatus for exciting a rare-earth-doped fiber by a laser beam, comprising the steps of: separating specific polarized waves of the exciting laser beam of an exciting laser using a polarizer; supplying the exciting laser beam of the separated polarized waves to the rare-earth-doped fiber for up-conversion and producing a laser output by resonance; returning part of the exciting laser beam emitted with the laser output from the rare-earth-doped fiber, to the rare-earth-doped fiber in association with the direction of polarization; and causing the exciting laser beam emitted with the laser output from the rare-earth-doped fiber in the same direction as the laser output due to the direction of polarization to proceed in the same direction as the direction of the laser output.

According to still another aspect of the present invention, there is provided an image display apparatus comprising: a plurality of fiber laser apparatuses, each apparatus outputting a red light beam, a green light beam and a blue light beam; a plurality of spatial modulation elements, each spatially modulating the light beams output from the fiber laser apparatuses; means for synthesizing the red light beam, the green light beam and the blue light beam spatially modulated by the plurality of the spatial modulation elements; and an optical element for focusing the output light of the synthesis means at a predetermined position; wherein at least one out of the plurality of the fiber laser apparatuses includes a polarizer inserted between an exciting laser for emitting an exciting laser beam and a rare-earth-doped fiber, and a high-reflection mirror for retrieving an up-conversion laser, and wherein that portion of the exciting laser beam output from the output side of the rare-earth-doped fiber which has polarized waves directed at right angles to the polarized waves incident on the rare-earth-doped fiber, is returned to the rare-earth-doped fiber, and the exciting laser beam having the other polarized waves is output in a direction different from the direction of the exciting laser.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram for explaining an example of a fiber laser apparatus to which an embodiment of the invention is applied;

FIG. 2 is a schematic diagram for explaining a first example of an input-output optical system adapted to be built in the fiber laser apparatus shown in FIG. 1;

FIG. 3 is a schematic diagram for explaining another example of an input-output optical system adapted to be built in the fiber laser apparatus shown in FIG. 1;

FIG. 4 is a schematic diagram for explaining an example of an image display apparatus having the fiber laser apparatus shown in FIGS. 1 to 3; and

FIG. 5 is a schematic diagram for explaining another example of an image display apparatus having the fiber laser apparatus shown in FIGS. 1 to 3.

### DETAILED DESCRIPTION OF THE INVENTION

Hereinafter, an example of a fiber laser apparatus to which the invention is applied will be explained below with reference to the accompanying drawings.

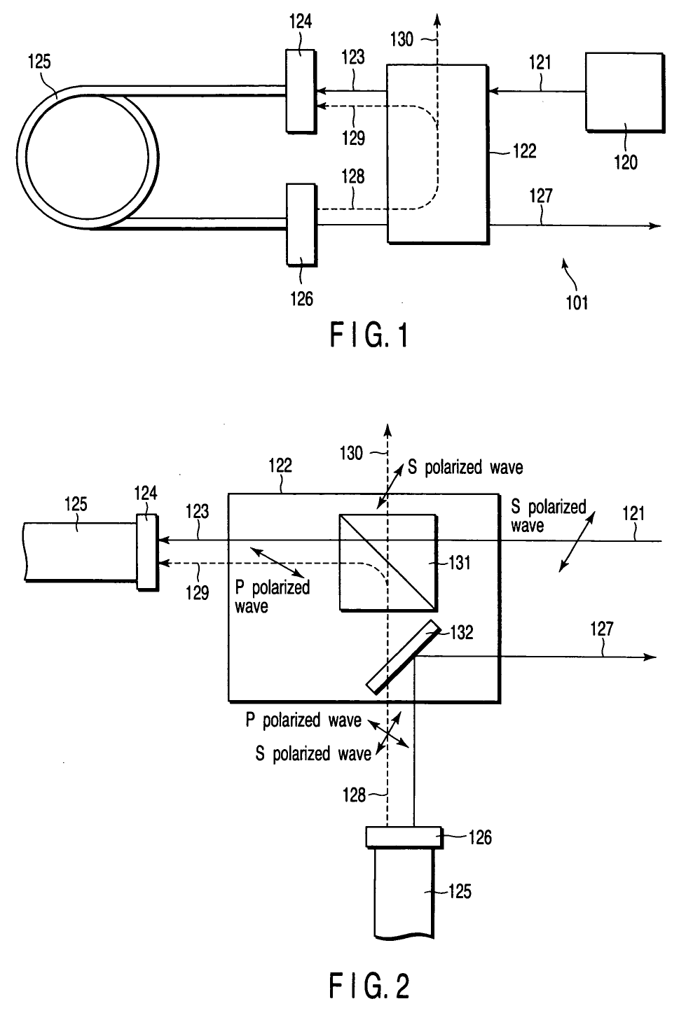

FIG. 1 shows an example of the fiber laser apparatus having an exciting laser, a polarizer and a high-reflection mirror.

An up-conversion fiber laser apparatus 101 includes an exciting laser 120 for emitting an exciting laser beam, an input-output optical system 122 for leading the exciting laser beam produced from the exciting laser to an up-conversion fiber (hereinafter, referred to simply as the rare-earth-doped fiber) 125, and an input-side mirror 124 and an output-side mirror 126 arranged on the input and output sides, respectively, of the rare-earth-doped fiber 125. Note that, an exciting laser beam 121 is, for example, a laser beam in an infrared region.

The input-output optical system 122 is configured of an polarizer for transmitting only the polarized light portion of the exciting laser beam 121 from the exciting laser 120.

The rare-earth-doped fiber 125 is a fiber to which at least one of the rare earths including Pr, Yb and Tm is doped. This fiber 125 absorbs the energy of the exciting laser beam 121 between the input-side mirror 124 and the output-side mirror 126, and outputs a laser beam of a desired wavelength through a combination of a low-reflection input-side mirror 124 and a high-reflection output-side mirror 126 or a high-reflection input-side mirror 124 and a low-reflection output-side mirror 126. The mirrors for red (R) light beam, for example, have a high reflectivity on input side and a low reflectivity on output side, so that the red light beam is output from the low-reflection side. Depending on the rare earth doped, a laser beam of an arbitrary wavelength can be obtained. In the case where Pr and Yb are doped, for example, a laser beam having a wavelength of 635 nm (or 490 nm, 520 nm, 604 nm or 695 nm) can be obtained. In the case where Tm is doped, on the other hand, a laser beam having a wavelength of 455 nm or 480 nm which is usable in the range of 460 nm to 470 nm for blue (B) display can be produced. Also, by doping Ho or Er, a laser beam having a wavelength of 545 nm usable for green (G) display can be obtained.

In the up-conversion fiber laser apparatus 101 described above, the exciting laser beam 121 from the exciting laser 120 enters the input-output optical system 122. The exciting laser beam entered into the input-output optical system 122 enters a resonator, i.e. the rare-earth-doped fiber 125 placed between the input-side mirror 124 and the output-side mirror 126, in the form of an exciting laser beam 123. As a result, the resonant laser beam 127 of the desired wavelength is output.

In addition to the laser beam 127, the exciting laser beam remaining unused for excitation is output from the output-side mirror 126 as an unabsorbed exciting laser beam 128. The unabsorbed exciting laser beam 128 having various polarized waves enters the input-output optical system 122 again. The polarized light (the reusable exciting laser beam, called the P polarized wave) 129 at right angles to the incident exciting laser beam, as explained below with reference to FIG. 2, is reflected from a polarized light beam splitter in the input-output optical system 122 and enters the rare-earth-doped fiber 125 again.

The light beam 130 having the same polarized waves as the one at the time of incidence is transmitted through the polarized light beam splitter in the input-output optical system 122 and output to a predetermined point without returning to the exciting laser 120.

FIG. 2 is a schematic diagram for explaining a first embodiment of the input-output optical system shown in FIG. 1. The component parts identical to those shown in FIG. 1 are designated by the same reference numerals, and are not described in detail below.

The input-output optical system 122 has a polarized light beam splitter 131 allowing only the waves polarized in a predetermined direction to pass therethrough and an exit mirror (high-reflection mirror) 132. Note that, the polarized light beam splitter 131 is arranged in such a manner that the transmissible polarized wave of the laser beam is an S polarized wave.

The exciting laser beam 121 having polarized waves in the vertical direction (called the S polarized waves), for example, is transmitted through the polarized light beam splitter 131 and the mirror 124 and enters the rare earth-doped fiber 125.

The exciting laser beam 123 with the S polarized waves that has entered the rare earth 125 is resonated between the input-side mirror 124 and the output-side mirror 126 and comes to form a desired laser beam 127.

The laser beam 127 that has been output from the output-side mirror 126 is reflected in the intended direction by the high-reflection mirror 132.

The remaining exciting laser beam 128 output in the same direction as the laser beam 127 through the output-side mirror 126, i.e. the S polarized wave component of the exciting laser beam 123 that has not been used as the exciting light beam is output as an unrequired light beam 130 in a predetermined direction different from the direction of the exciting laser 120 through the polarized beam splitter 131.

The P polarized wave component of the remaining exciting laser beam 128, on the other hand, is reflected on the polarized beam splitter 131, and input again like the exciting laser beam 123 of the S polarized waves described above.

As a result, the exciting laser beam output without being absorbed can be reused. Therefore, the utilization rate of the exciting laser beam is improved while the exciting laser light beam returned to the semiconductor laser can be eliminated.

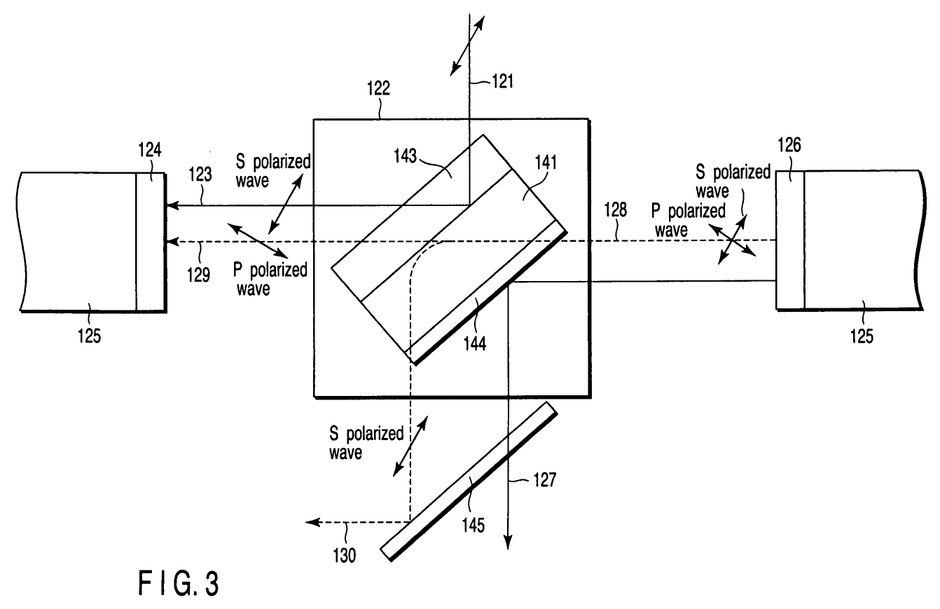

FIG. 3 is a schematic diagram for explaining another embodiment of the input-output optical system shown in FIG. 1. In FIG. 3, the component parts identical to those shown in FIGS. 1 and 2 are designated by the same reference numerals and are not described in detail below.

In FIG. 3, the input-output optical system 122 includes a beam splitter unit 141 having a polarized beam splitter 143 allowing only the waves polarized in a predetermined direction to pass therethrough and an exit mirror (high-reflection mirror) 144 integrated with the polarized beam splitter 143. Note that, the polarized beam splitter 143 of the beam splitter unit 141 is arranged in such a manner that the exciting laser beam 121 constituting S polarized waves can be reflected.

Specifically, the exciting laser beam 121 produced from the exciting laser 120 is reflected on the polarized beam splitter 143 of the input-output optical system 122 and enters the rare-earth-doped fiber 125 through the mirror 124.

The exciting laser beam 123 of the S polarized waves input to the rare-earth-doped fiber 125 is resonated between the input-side mirror 124 and the output-side mirror 126 and comes to form the desired laser beam 127.

The laser beam 127 output from the output-side mirror 126 is reflected in the intended direction from the high-reflection mirror 144.

The P polarized wave component of the remaining exciting laser beam 123 output from the mirror 126 at the same time as the laser beam 127 and not used as an exciting laser beam, is input again to the rare-earth-doped fiber 125 like the exciting laser beam 123 of the S polarized waves described above through the polarized beam splitter 143.

The S polarized wave component of the remaining exciting laser beam 123 that has not been used as an exciting laser beam, on the other hand, is output as an unrequired light beam 130 in the same direction as the laser beam 127. Note that, the unrequired light beam 130 is reflected in a direction different from the laser beam 127, for example, by the mirror 145 which reflects the infrared light beam.

The separation of the unrequired light beam 130 explained above with reference to FIG. 2 or 3 is accomplished in the following manner. Specifically, a specified polarized wave of the exciting laser beam 121 produced from the exciting laser 120 is separated using the polarizer 131 (143), and the exciting laser beam of the polarized waves thus separated is resonated by being supplied to the up-conversion rare-earth-doped fiber 125 thereby to produce a laser output 127. The portion 129 of the exciting laser beam 128 emitted from the rare-earth-doped fiber 125 with the laser output is returned to the rare-earth-doped fiber 125 again in a direction associated with the polarized waves, and emitted from the rare-earth-doped fiber 125 as an exciting laser beam 128 together with the laser output. The exciting laser beam 130 emitted in the same direction as the laser output 127 which is the direction associated with the polarized waves are caused to proceed in a direction different from the laser output 127.

As a result, the exciting laser beam that has been output without being absorbed can be reused, thus improving the utilization rate of the exciting laser beam while the light beam returned to the exciting laser can be eliminated.

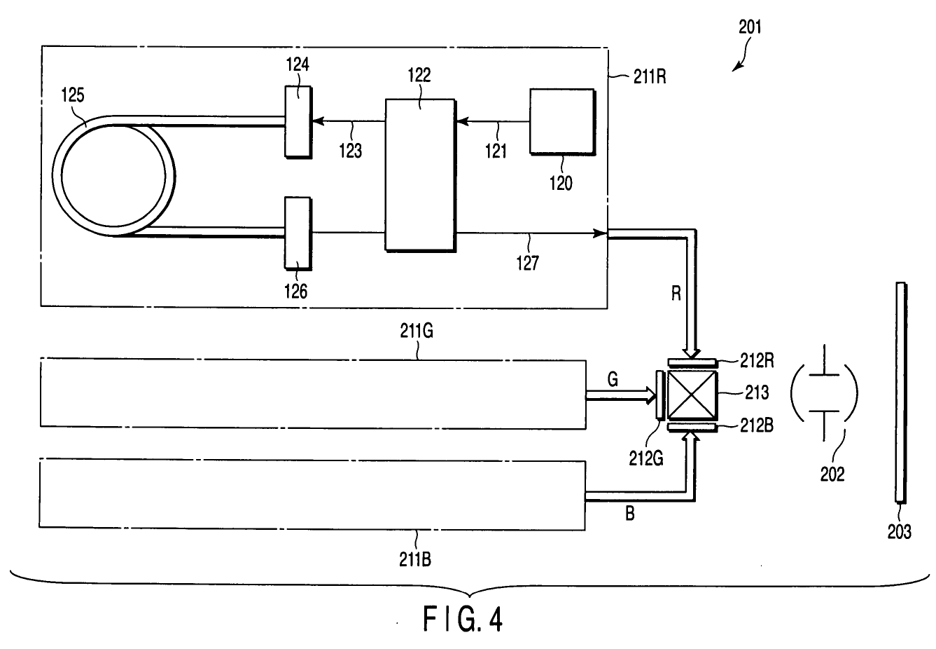

FIG. 4 is a schematic diagram for explaining an example of an image display apparatus having the fiber laser apparatus shown in FIGS. 1 to 3.

As shown in FIG. 4, the image display apparatus 201 contains first to third light sources 211R, 211G and 211B for displaying a color image by the additive color process. At least one of the three light sources, or the red light source 211R, for example, is constituted of an up-conversion fiber laser as a rare-earth-doped fiber 125 with Pr and Yb doped thereto in the fiber laser apparatus (designated by numeral 101 in FIG. 1) explained above with reference to FIGS. 1 to 3. The green light source 211G, for example, can also employ an up-conversion fiber laser as a rare-earth-doped fiber 125 with Pr and Yb, or Ho or Er doped thereto in the fiber laser apparatus explained above with reference to FIGS. 1 to 3. The blue light source 211B, for example, can use an up-conversion fiber laser as a rare-earth-doped fiber 125 with Tm doped thereto in the fiber laser apparatus (designated by numeral 101 in FIG. 1) explained above with reference to FIGS. 1 to 3.

The R, G and B light beams of a predetermined intensity are emitted from the fiber laser apparatuses 211R, 211G and 211B, respectively.

The light beams emitted from the fiber laser apparatuses 211R, 211G and 211B are spatially modulated by entering liquid crystal panels 212R, 212G and 212B for displaying R, G and B images, respectively.

The R, G and B light beams spatially modulated are synthesized by synthesis means such as a dichroic prism 213 and enter a projection lens 202.

The light beam that has exited from the projection lens 202 is displayed as a color image on a screen 203.

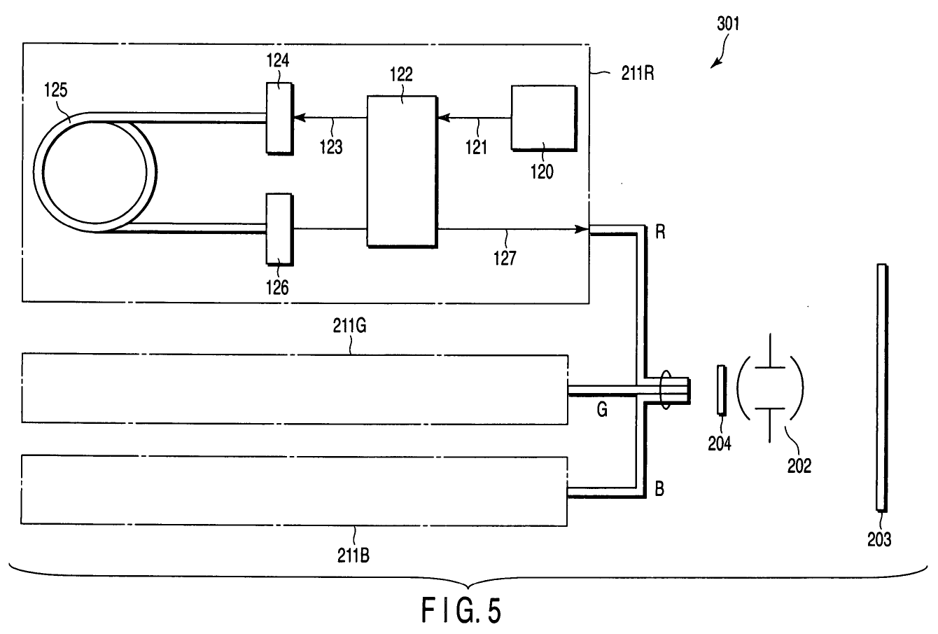

FIG. 5 is a schematic diagram for explaining another example of the image display apparatus shown in FIG. 4. The component parts identical to those shown in FIG. 4 are designated by the same reference numerals, and are not described in detail below.

As shown in FIG. 5, the image display apparatus 301 has first to third light sources 211R, 211G and 211B for displaying a color image by the additive color process and a liquid crystal panel 204 capable of color display of the image to be projected by the light beams from each light source. At least one of these light sources, or for example, the red light source 211G employs the fiber laser apparatus 101 explained above with reference to FIGS. 1 to 3.

Macroscopically, the three light beams output from the fiber laser apparatuses 211R, 211G and 211B can be regarded substantially as white light, in a state synthesized by a white color generating mechanism not shown, or in a state with the photoconductive members arranged close to each other for guiding the light beams from the three fiber laser apparatuses, and viewed from a position a predetermined distance away. The fiber laser apparatuses 211R, 211G and 211B, therefore, can be used for projecting on the screen 203 the image displayed on the liquid crystal panel 204 having a color filter.

As described above, the image display apparatus shown in FIG. 4 or 5 employs fiber laser apparatuses for display each constituted of an input-output optical system including a polarizer and a high-reflection mirror whereby the exciting laser beam output without being absorbed can be reused. Thus, the utilization rate of the exciting laser beam is improved on the one hand and the laser beam which otherwise might return to the exciting laser can be eliminated at the same time.

This invention is not limited to the embodiments described above, but can be variously modified or changed without departing from the scope and spirit of the invention. The embodiments can be appropriately combined as far as possible, in which case the effects of the combination can be produced.

It will thus be understood from the foregoing detailed description that according to this invention, the utilization rate of the exciting laser beam can be improved in case that an up-conversion fiber laser apparatus as each display light source is used.

Also, the return light from the up-conversion fiber is eliminated, i.e., the portion of the exciting laser beam that has not been used for excitation is not returned to the semiconductor laser, and therefore the exciting laser beam output is stabilized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An up-conversion fiber laser apparatus for exciting a rare-earth-doped fiber by a laser beam, comprising:
a polarizer and a high-reflection mirror for retrieving an up-conversion laser output, which are arranged between an exciting laser for emitting an exciting laser beam and the rare-earth-doped fiber,
wherein that portion of the exciting laser output from the output side of the rare-earth-doped fiber which has polarized waves at right angles to the polarized waves of the light beam incident or the rare-earth-doped fiber is returned into the rare-earth-doped fiber again, and the exciting laser beam having the other polarized waves are output in a direction different from the exciting laser.

2. A fiber laser apparatus according to claim 1,
wherein the polarizer and the high-reflection mirror are formed integrally with each other.

3. A fiber laser apparatus according to claim 2, further comprising:
a separator interposed between the high-reflection mirror and the output side of the rare-earth-doped fiber for separating the up-conversion laser output from the rare-earth-doped fiber and the exciting laser beam having the other polarized waves from each other.

4. A fiber laser apparatus according to claim 3,
wherein the rare-earth-doped fiber has doped thereto at least one of Pr, Yb and Tm.

5. A fiber laser apparatus comprising:
an exciting laser for emitting an exciting laser beam;
an up-conversion fiber excited by the exciting laser beam and adapted to output a laser beam of a wavelength predetermined in accordance with the rare-earth doped in advance;
a polarizer interposed between the exciting laser and the up-conversion fiber for transmitting the light beam having a polarized wave component unique to the exciting laser beam and reflecting the light beam having a polarized wave component at right angles to the unique polarized wave component; and
an output mirror arranged on the output side of the up-conversion fiber and adapted to guide, in a predetermined direction different from the exciting laser, the output laser beam output from the up-conversion fiber and the portion of the exciting laser beam not contributing to the excitation of the up-conversion fiber of the exciting laser beam.

6. A fiber laser apparatus according to claim 5,
wherein the polarizer is arranged in such a manner that the polarized light beam component of that portion of the exciting laser beam transmitted through the output mirror and not contributing to the excitation of the up-conversion fiber which is at right angles to the polarized light beam component incident on the polarizer from the exciting laser can be input to the up-conversion fiber.

7. A fiber laser apparatus according to claim 6, further comprising a separator arranged downstream of the output mirror for separating the output laser beam of the up-conversion fiber from that portion of the polarized light beam component of the exciting laser beam transmitted through the polarizer which fails to contribute to the excitation of the up-conversion fiber.

8. A fiber laser apparatus according to claim 7,
wherein the rare-earth-doped fiber has doped thereto at least one of Pr, Yb and Tm.

9. An exciting method for an up-conversion fiber laser apparatus for exciting a rare-earth-doped fiber by a laser beam, comprising the steps of:
separating specific polarized waves of the exciting laser beam of an exciting laser using a polarizer;
supplying the exciting laser beam of the separated polarized waves to the rare-earth-doped fiber for up-conversion and producing a laser output by resonance;
returning part of the exciting laser beam emitted with the laser output from the rare-earth-doped fiber, to the rare-earth-doped fiber in association with the direction of polarization; and
causing the exciting laser beam emitted with the laser output from the rare-earth-doped fiber in the same direction as the laser output due to the direction of polarization to proceed in the same direction as the direction of the laser output.

10. An excitation method for an up-conversion fiber laser apparatus according to claim 9,
wherein the polarized waves of the exciting laser beam returned to the rare-earth-doped fiber again and the polarized waves of the exciting laser beam emitted in the same direction as the laser output by the polarizer from the rare-earth-doped fiber are directed at right angles to each other.

11. An excitation method for an up-conversion fiber laser apparatus according to claim 9, further comprising:
wherein the exciting laser beam emitted in the same direction as the laser output from the rare-earth-doped fiber is caused to proceed in a direction different from the direction of the laser output by use of a mirror capable of reflecting the infrared light.

12. An image display apparatus comprising:
a plurality of fiber laser apparatuses, each apparatus outputting a red light beam, a green light beam and a blue light beam;
a plurality of spatial modulation elements, each spatially modulating the light beams output from the fiber laser apparatuses;
means for synthesizing the red light beam, the green light beam and the blue light beam spatially modulated by the plurality of the spatial modulation elements; and
an optical element for focusing the output light of the synthesis means at a predetermined position;
wherein at least one out of the plurality of the fiber laser apparatuses includes a polarizer inserted between an exciting laser for emitting an exciting laser beam and a rare-earth-doped fiber, and a high-reflection mirror for retrieving an up-conversion laser, and
wherein that portion of the exciting laser beam. output from the output side of the rare-earth-doped fiber which has polarized waves directed at right angles to the polarized waves incident on the rare-earth-doped fiber, is returned to the rare-earth-doped fiber, and the exciting laser beam having the other polarized waves is output in a direction different from the direction of the exciting laser.

13. An image display apparatus according to claim 12,
wherein the rare-earth-doped fiber has doped thereto at least one of Pr, Yb and Tm.

14. An image display apparatus according to claim 12, further comprising:
a white light generating mechanism for processing each of the output light beams of the plurality of the fiber laser apparatuses in such a manner as to form a substantially white light beam;
wherein the spatial modulation element is single in number and spatially modulates the output light beam of the white light generating mechanism in accordance with the image information to be displayed.

15. An image display apparatus according to claim 14,
wherein the rare-earth-doped fiber has doped thereto at least one of Pr, Yb and Tm.
